(19) United States
(12) Patent Application Publication
(10) Pub. No.: US 2011/0253359 A1
(43) Pub. Date: Oct. 20, 2011

(54) SYSTEM AND METHOD FOR SENSING AIR FLOW, CARBON DIOXIDE OR VOLATILE ORGANIC COMPOUND IN RESIDENTIAL BUILDING

(75) Inventor: John Stockton, Austin, TX (US)

(73) Assignee: ZETA Communities, Zero Energy Technology & Architecture

(21) Appl. No.: 12/762,053

(22) Filed: Apr. 16, 2010

(51) Int. Cl. F24F 11/04; G05D 23/19; F24F 11/00

(52) U.S. Cl. 165/250; 165/251; 165/291; 165/295

(57) ABSTRACT

An apparatus and a method for controlling an HVAC system in a building are provided. The apparatus may include: (a) sensors provided at different locations inside and outside of the building each providing an electrical output signal representative of a measured condition, wherein the sensors sense two or more of the following conditions: temperature, carbon dioxide and volatile organic compound conditions; (b) an embedded computer receiving the electrical output signals of the sensors and based upon which provides a plurality of output control signals; and (c) HVAC actuators operating in accordance with the output control signals, wherein the HVAC actuators affect a climatic condition or an air quality condition at one or more locations where the sensors are located.

### BACKGROUND OF THE INVENTION

1. Field of the Invention

The present invention relates to heat, ventilation and air conditioning (HVAC) systems in residential buildings. In particular, the present invention relates to controlling an HVAC system in a residential building to maintain climate and air quality.

2. Discussion of the Related Art

In a well-sealed home, forcing an exchange of air between the interior and the exterior is necessary to prevent indoor pollutants to rise to unhealthy levels. Typically, a timer controls opening of a mechanical vent periodically to effectuate the exchange, while an HVAC blower is operating. Such a system has been referred to as an “air cycler” or an “air exchanger.”

A similar system is referred to as an “economizer,” which pulls air from the exterior into the interior, whenever the exterior temperature is closer to the desired temperature than the interior temperature. In some localities, moderated by such an air exchange, the economizer may obviate a need for running a compressor or a heater.

In the prior art, temperature control and air quality control are each carried out by different controllers that are independently programmed without taking into consideration of the other. The result is often excessive venting of the building, leading to energy inefficiency. To remedy this problem, one control system tracks economizer's total time of operation over a given time period and shortens the cycler's total time of operation by the same amount over the same timer period. However, such an “open loop” control mechanism is merely a crude approximation to an appropriate total duration of vent operation, and does not take into consideration actual air quality factors at any given time (e.g., the occupancy in the building, the actual level of pollutants).

### SUMMARY

According to one embodiment of the present invention, an apparatus and a method for controlling an HVAC system in a building are provided. The apparatus may include: (a) sensors provided at different locations inside and outside of the building each providing an electrical output signal representative of a measured condition, wherein the sensors sense two or more of the following conditions: temperature, carbon dioxide and volatile organic compound conditions; (b) an embedded computer receiving the electrical output signals of the sensors and based upon which provides a plurality of output control signals; and (c) HVAC actuators operating in accordance with the output control signals, wherein the HVAC actuators affect a climatic condition or an air quality condition at one or more locations where the sensors are located.

In one embodiment, the HVAC actuators includes one or more mechanical vents, each of which being provided an air flow meter that measures air flow through the vent during operation. In such a system, the embedded computer takes into consideration the air flow measured by the air flow meter in controlling air exchanges between the inside and the outside of the building.

The present invention is better understood upon consideration of the detailed description below in conjunction with the accompanying drawings.

### BRIEF DESCRIPTION OF THE DRAWINGS

FIG. 1 shows closed loop HVAC system 100, in accordance with one embodiment of the present invention.

### DETAILED DESCRIPTION OF THE PREFERRED EMBODIMENTS

The present invention provides a closed-loop control system that allows air exchange between the interior and the exterior of a well-sealed building based on actual climatic and air quality conditions.

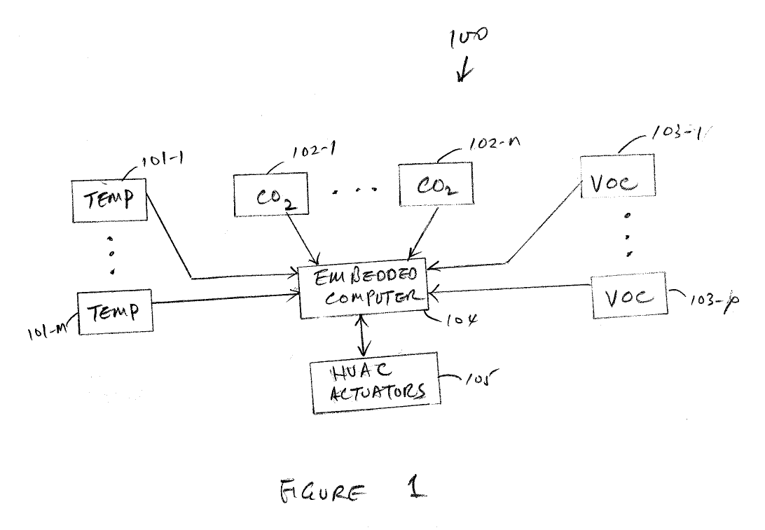

FIG. 1 shows closed loop HVAC system 100, in accordance with one embodiment of the present invention. As shown in FIG. 1, system 100 includes temperature sensors 101-1 to 101-m, carbon dioxide sensors 102-1 and 102-n and volatile organic compound (VOC) sensors 103-1 to 103-p, which are each placed at different locations inside or outside of the building to sense temperature, carbon dioxide or VOC concentrations at their respective locations. (Although shown as numerous, temperature sensors 101-1 to 101-m, carbon dioxide sensors 102-1 and 102-n and VOC sensors 103-1 to 103-p represent at least one sensor of each type; the appropriate number for each type of sensors depends on the actual size, number of rooms and expanse of the building). These sensors each provide an electrical signal output to indicate the measured condition of its location. There are many such sensors available in the marketplace. For example, temperature may be sensed by thermocouples, carbon dioxide may be sensed by non-dispersive infra-red radiation or by various chemical-based sensors, and VOC may be sensed by indium-tin oxide-based sensors. As shown in FIG. 1, the output electrical signals of these sensors are provided to embedded computer 104, which uses the sensed conditions to operate HVAC actuators 105 (e.g., compressors, heaters, fans, or mechanical vent controls). When HVAC system 105 operates, the conditions giving rise, for example, to the need for opening vents, are corrected, The corrected conditions are reflected in the sensor measurements, which in turn cause embedded computer 104 to adjust HVAC system 105 to the ameliorated conditions. If appropriate, air flow meters may be provided (e.g., next to vents) to measure the air flow pulled into the building when the vents are operated under control of embedded computer 104 or another coexisting ventilation system.

Embedded computer 104 operates compressors, heaters, fans and vents based on algorithms included in its software, with programmable climatic and air quality parameters. For example, in one embodiment, the vents are opened when the average exterior temperature is closer to desired temperature than the average interior temperature. Similarly the vents are opened when the average carbon dioxide or VOC concentration exceeds a predetermined threshold, or when at least one of the carbon dioxide sensor or VOC sensor exceeds a threshold that indicates an unacceptable concentration. When air flow meters are provided, the actual measured flow pulled in from the exterior in response to an air quality measurement is used to adjust the basic air cycling requirement. Alternatively, an estimated air flow, based on the duration of vent operation in response to an air quality measurement, the size of each vent and the power of each fan operated, may also be used to adjust the cycling requirement. An additional economizer system is therefore obviated.

The above detailed description is provided to illustrate the specific embodiments of the present invention and is not intended to be limiting. Numerous variations and modifications within the scope of the present invention are possible. The present invention is set forth in the accompanying claims.

1. An HVAC system in a building, comprising:
a plurality of sensors provided at different locations inside and outside of the building each providing an electrical output signal representative of a measured condition, wherein the sensors sense two or more of the following conditions: temperature, carbon dioxide and volatile organic compound conditions;
an embedded computer receiving the electrical output signals of the sensors and based upon which provides a plurality of output control signals; and
a plurality of HVAC actuators operating in accordance with the output control signals, wherein the HVAC actuators affect a climatic condition or an air quality condition at one or more locations where the sensors are located.

2. An HVAC system as in claim 1, wherein the HVAC actuators comprise at least one vent, the HVAC system further comprising an air flow meter that measures air flow through the vent during operation.

3. An HVAC system as in claim 2, wherein the embedded computer takes into consideration the air flow measured by the air flow meter in controlling air exchanges between the inside and the outside of the building.

4. A method for controlling an HVAC system in a building, comprising:
locating a plurality of sensors at different locations inside and outside of the building, the sensors each providing an electrical output signal representative of a measured condition, wherein the sensors sense two or more of the following conditions: temperature, carbon dioxide and volatile organic compound conditions;
receiving at an embedded computer the electrical output signals of the sensors;
based upon the received electrical output signals, providing from the embedded computer a plurality of output control signals; and
operating a plurality of HVAC actuators in accordance with the output control signals, wherein the HVAC actuators affect a climatic condition or an air quality condition at one or more locations where the sensors are located.

5. A method as in claim 4, wherein the HVAC actuators comprise at least one vent, the method further comprising measuring an air flow through the vent during operation using an air flow meter.

6. A method as in claim 5, wherein the embedded computer takes into account the air flow measured by the air flow meter in controlling air exchanges between the inside and the outside of the building.
